(19) United States
(12) Patent Application Publication
(10) Pub. No.: US 2008/0014548 A1
(43) Pub. Date: Jan. 17, 2008

(54) Periodontal pocket irrigator

(76) Inventor: Christine M. Paxton, Sterling, IL (US)

Correspondence Address: GREER, BURNS & CRAIN, 300 S WACKER DR, 25TH FLOOR, CHICAGO, IL, 60606, US

(21) Appl. No.: 11/804,258

(22) Filed: May 17, 2007

Related U.S. Application Data
(60) Provisional application No. 60/801,141, filed on May 17, 2006.

(51) Int. Cl. A61C 17/02

(52) U.S. Cl. 433/90

(57) ABSTRACT

A periodontal irrigator flushes out bacteria at the base of a periodontal pocket. The periodontal pocket irrigator is a handheld device that can be used by patients in their homes to irrigate periodontal pockets. The device includes a handle, a liquid container, and a mechanism for filling the container with Listerine, water, antibacterial fluid, or various prescriptions to treat periodontal disease. The container can be easily removed for cleaning. The liquid contents can be dispensed from the container through a removable tip by a motor. Dispensing can be continuous, or limited to predetermined doses. The dispensing tip is angled, and can be oriented in more than one direction with respect to the handle. The device can include a light to illuminate the mouth, as periodontal disease frequently starts in the interproximal area of the molars in the darker parts of the mouth.

This application claims priority under 35 U.S.C. §119 from co-pending provisional application Ser. No. 60/801,141, filed May 17, 2006.

### FIELD OF THE INVENTION

This invention relates to periodontal irrigators, and more particularly to periodontal pocket irrigators for patients' home use.

### BACKGROUND OF THE INVENTION

It is estimated that one in three adults in the United States has some form of periodontal disease. Periodontal disease, including gingivitis and periodontis, are infections that if left untreated can lead to tooth loss. These diseases are chronic bacterial infections that infect the gums and bones surrounding teeth.

Periodontal disease is caused by bacteria in plaque causing the gums to become inflamed. In an initial form of the disease (gingivitis), the gums redden, swell and bleed easily. If left untreated, gingivitis can lead to periodontis, which is caused by plaque spreading and growing below the gum line. This bacteria irritates the gums, which in turn stimulates a chronic inflammatory response in which the gums separate from the teeth, forming pockets (spaces between the teeth and gums that frequently become infected). As periodontal disease progresses, the pockets deepen and the infection advances.

In order to stop the progression of periodontal disease, the periodontal pockets must be kept clean of plaque and bacteria. A home care program typically entails brushing, flossing, and irrigating these periodontal pockets with water or antibacterial agents. However, there exists a need for a hand-held periodontal irrigator that is easy to use as part of this home treatment.

### SUMMARY OF THE INVENTION

In keeping with one aspect of this invention, a periodontal irrigator is designed to flush out bacteria at the base of periodontal pockets. The periodontal pocket irrigator is a handheld device that can be used by patients in their homes to clean periodontal pockets. The device includes a handle, a liquid container filled with Listerine®, water, antibacterial fluid, or various prescriptions to treat periodontal disease, and a mechanism to dispense the contents of the liquid container. The container can be easily removed for cleaning.

The liquid contents can be dispensed through a removable tip by a motor. Dispensing can be continuous, or limited to predetermined doses. The dispensing tip is preferably angled, and can be positioned in more than one orientation with respect to the handle. The device can include a light to illuminate the mouth, as periodontal disease frequently starts in the interproximal area of the molars in the darker parts of the mouth.

### BRIEF DESCRIPTION OF THE DRAWINGS

The above mentioned and other features of this invention and the manner of obtaining them will become more apparent, and the invention itself will be best understood by reference to the following description of an embodiment of the invention taken in conjunction with the accompanying drawings, in which:

FIG. 1 is a side plan view of an embodiment of the periodontal pocket irrigator of the present invention;

FIG. 2 is a partial cutaway view of the irrigator of FIG. 1;

FIG. 3 is a side plan view of an alternate embodiment of the periodontal pocket irrigator of the present invention;

FIG. 4 is a front view of the irrigator of FIG. 1;

FIG. 5 is an exploded view of the front end of a first alternate embodiment of the periodontal pocket irrigator of the present invention;

FIG. 6 is an exploded view of the front end of a second alternate embodiment of the periodontal pocket irrigator of the present invention; and

FIG. 7 is an exploded view of the front end of a third alternate embodiment of the periodontal pocket irrigator of the present invention.

### DETAILED DESCRIPTION

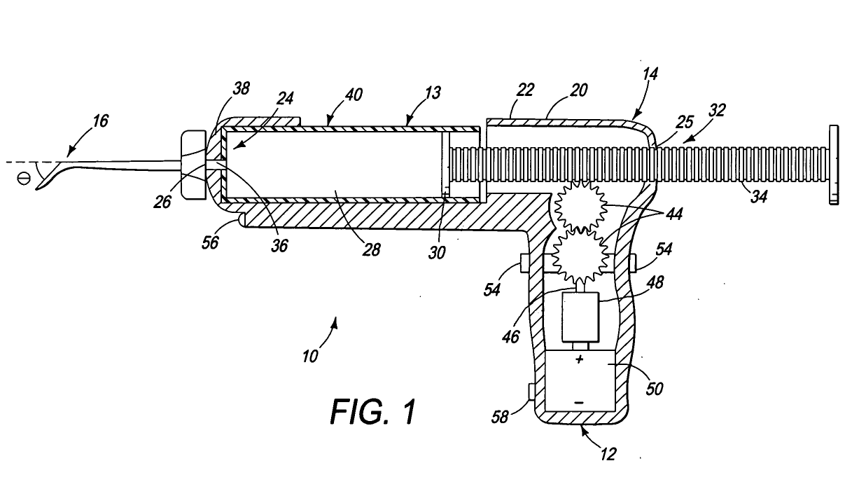

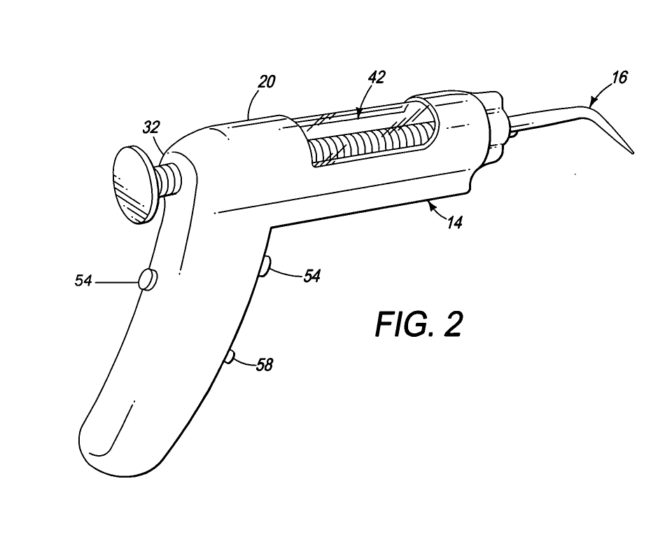

As seen in FIGS. 1 and 2, a periodontal pocket irrigator 10 has a handle 12 attached to a barrel 14, which is attached to a dispenser 16. The barrel 14 contains a cylindrical chamber 18, which is accessed by opening a hinged door 20 on barrel top 22. Chamber 18 has an opening 26 at chamber front end 24 through which fluid may flow to the dispenser 16.

A removable syringe 28, which can be filled with water, an antibacterial fluid or the like, is placed in the chamber 18. The syringe 28 has a plunger 30 which is attached to a shaft 32. Shaft 32 projects from chamber rear end 25 when a fully loaded syringe is placed in chamber 18. The rear end 25 of chamber 18 adjacent to handle 12 has an opening at least large enough to admit the shaft 32 of syringe 28. The shaft 32 includes ribs 34 on at least part of its circumference.

The syringe 28 is initially loaded with fluid by placing the syringe tip 36 in treating fluid and then retracting plunger 30 until syringe 28 is filled. After the hinged door 20 is opened, the syringe tip 36 may placed into an indentation 38 at chamber front end 24. Syringe tip 36 and indentation 38 are preferably designed to mate so that a fluid seal is formed when syringe tip 36 is placed into indentation 38. The syringe is then held in place by closing the hinged door 20. Axial movement of the syringe can be prevented by retaining clips or the like.

Barrel 14 preferably contains a cutout 40 in barrel top 22 through which the syringe may be viewed by a user. Alternately this cutout can be replaced by a transparent window 42 as shown in FIG. 2.

When the syringe 28 is secured in place, the ribs 34 of the syringe shaft 32 engage a drive transmission mechanism 44 attached to motor 48. In the embodiment shown in FIG. 1, this mechanism consists of two spur gears that engage a spindle 46 of motor 48. Any sort of drive transmission mechanism may be used to transmit the rotation of motor spindle 46 to the ribs 34 of shaft 32. Alternately, this mechanism could be omitted altogether and the gears on the rotating spindle 46 may directly engage the ribs of plunger shaft 30.

Motor 48 is powered by battery 50. Motor 48 is preferably activated by a user-controlled motor drive switch 54, which is preferably a button-type switch actuated by the user, which completes a circuit between the motor 48 and the battery 50. The motor drive switch may use either manual or timed control. With manual control, the motor operates when the user depresses the motor drive switch 54 and continues to operate as long as the button remains depressed. In timed operation, the device is programmed to dispense a predetermined amount of fluid when the motor drive button 54 is pressed. The fluid can be metered by a timer that actuates the motor for a predetermined time advancing the shaft a predetermined distance thus dispensing a predetermined volume of fluid. This timer can be any form of conventional circuit or control known in the art.

Preferably a light source 56 such as an LED is provided at the barrel front adjacent to the dispensing assembly 16. This light source is activated by a light control 58, which is preferably an on/off push button mechanism where the circuit is open or shut by depressing a button such that the user need not continuously operate the control. The light source 56 is powered by battery 50.

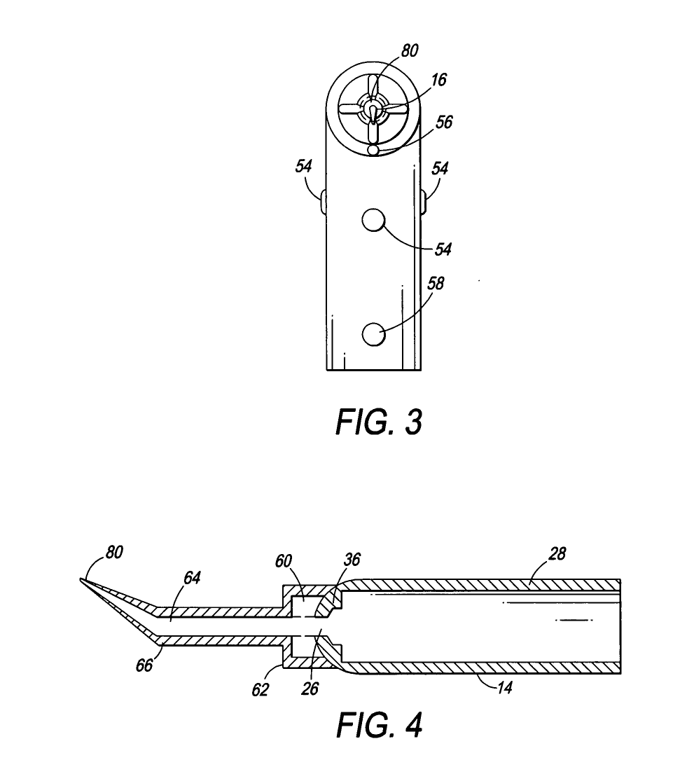

The light control button 58 and motor control button 54 may be located on the front of the handle, the rear of the handle or one of its sides, as seen in FIGS. 1-3. More than one motor control button 54 can be used, if desired, for both left handed and right handed use and different user grips, as it is believed that users may hold the device differently depending upon the location of the periodontal pocket to be irrigated.

To use the irrigator 10, the user turns on light 56 by depressing light control button 58, so that the user can see the pocket to be irrigated in a mirror and the user can position the dispensing tip 16 in the periodontal pocket to be irrigated. The user then depresses the motor drive button 54, activating the motor 48, driving the spindle 48, through the mechanical linkage 46, which engages the ribs 34 of shaft 32, advancing the plunger 30 towards the syringe tip 36. This forces the fluid contents from the syringe 18 through the opening 26 through dispensing tip 16 into the periodontal pocket.

Turning now to FIG. 4, the dispensing tip 16 may be a multi-part apparatus including a base portion 60 attached to the front end of barrel 14 and a removable tip 62. The removable tip 62 may include a metal cannula 64, which is encased in an outer sheath 66 as shown in FIG. 4. Sheath 66 is preferably made of soft plastic or rubber. Alternately, the removable tip 62 may be made entirely of soft plastic or rubber.

The removable tip may include an angled fluid path defined by two segments. For example, as shown in FIG. 1, the first segment runs along the axis of the syringe 28 and then from this axis bends at an angle Θ to the second which ends at the discharge point 80. In the embodiment shown in FIG. 1, this angle (180°-Θ) is approximately 45°. The angle between the segments of the removable tip may be any angle sufficient to enable the device to be oriented with respect to periodontal pockets in the user's upper or lower teeth while handle 19 is gripped in a convenient position.

The removable adjustable tip 62 is preferably secured to the base portion 60 in any suitable way. Preferably removable tip 62 is secured to the base portion 60 in such a manner as to allow the tip to be rotated to multiple orientations, to enable the placement of the angled portion of the adjustable tip in multiple positions with respect to a periodontal pocket in the user's mouth so that fluid can be dispensed through discharge point 80 into pockets on the inside, or outside of teeth in the upper or lower jaw.

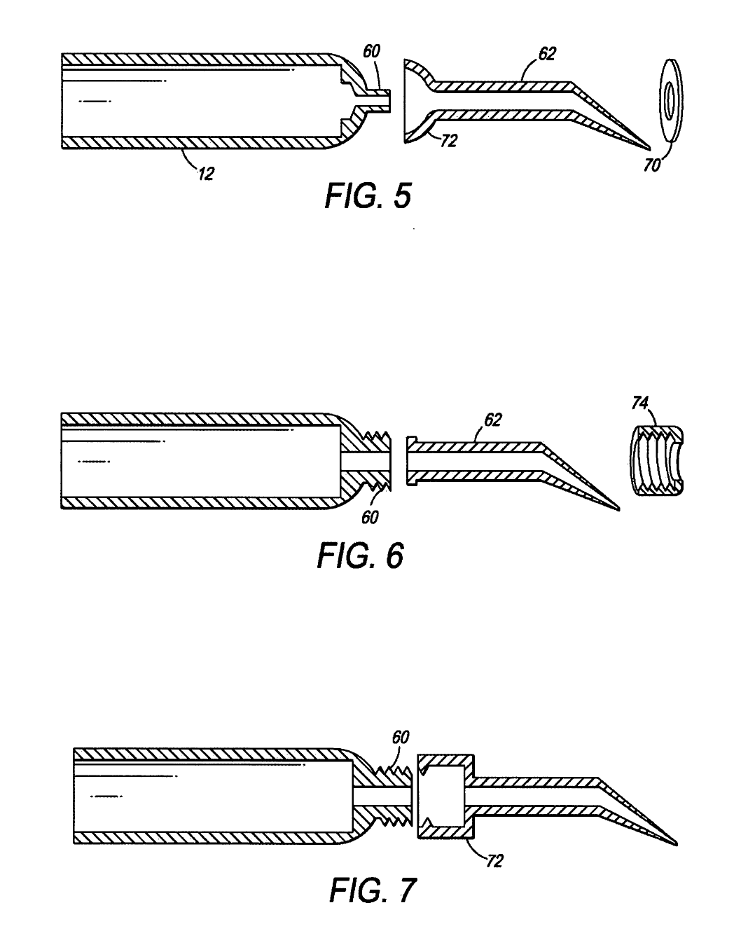

In one embodiment shown in FIG. 5 a ring 70 is used to secure the tip 62 to the base 60. In this embodiment, base 62 is generally conical or cylindrical and the removable tip has a flange 72 at the end opposite the angled tip. In this embodiment, the tip is secured in place by ring 70 which holds the removable tip 62 against the base 60. Once the tip 62 is placed atop the base 64, and the tip flange 72 is flush against the front of the barrel, the ring 70 is positioned over the tip 62, and the tip 62 passes through an opening in the ring 66, until the ring 66 compresses the tip 62 around the base 60. The ring 76 can later be pulled away from the barrel 14 to permit rotation of the tip 62 to a desired orientation and re-tightened. Thus the tip can be easily removed and discarded when desired.

In this manner, the tip and ring form a seal that prevents the escape of the fluid, but allows the tip to rotate with respect to the axis of the syringe shaft.

The position of dispensing tip 62 is controlled by loosening the ring 72, which enables the tip to be oriented in different positions or orientations. It is anticipated that at least four positions, or continuous positions, will be provided for the pocket irrigator, so that pockets on either side of a tooth on either side of the mouth, on the upper or lower jaw, may be irrigated.

Alternately, in an alternate embodiment shown in FIG. 6, a cap with an annular hole is used instead of a ring. Cap 74 has a hole sized to permit dispensing tip 62 to project through it. Cap may be made of plastic with interior threads. In this embodiment, the base 60 is also threaded and the dispensing tip 62 has a planar base that abuts atop the top surface of base 60. The cap is placed over the dispensing tip and tightened onto the base threads, holding the tip in place.

In another alternate embodiment shown in FIG. 7, a cap shaped section is incorporated directly into the removable tip 62 with a single projection or layer of threads. The threads on base 60 are similarly missing at least one layer of threads so that when the tip 62 is completely threaded onto the base, it will overshoot the threads on the base, and be able to rotate freely on the base 62.

While the principles of the invention have been described above in connection with specific apparatus and applications, it is to be understood that this description is made only by way of example and not as a limitation on the scope of the invention.

What is claimed is:

1. A periodontal pocket irrigator comprising:
a dispenser comprising a handle attached to a barrel, said barrel being attached to a dispensing tip;
a removable syringe having a plunger where a fluid is dispensed by the advancement of said plunger towards a dispensing end of said syringe, said removable syringe being releasably secured in said barrel so that said syringe is in fluid communication with said dispensing tip;
a drive mechanism comprising a battery-powered motor contained within said handle mechanically linked to said plunger advance said plunger towards said dispensing tip to dispense fluid from said syringe; and
an actuator to control the operation of said motor and the advancement of the plunger;

2. The irrigator of claim 1, further comprising a light source adjacent said dispensing tip and powered by said battery.

3. The irrigator of claim 2, where the light source is a LED.

4. The irrigator of claim 1, where the syringe is secured by a hinged door in the barrel.

5. The irrigator of claim 1 where said dispensing tip includes a removable tip portion attached to the front of said barrel.

6. The irrigator of claim 5, where said removable tip portion comprises at least two segments, the first segment attached to the front of said barrel being parallel to the axis of the syringe and the second segment being at an angle Θ to the axis of the syringe and terminating in a dispensing point.

7. The irrigator of claim 6, where the angle Θ is between 30 and 60 degrees.

8. The irrigator of claim 7, where the angle Θ is approximately 45 degrees.

9. The irrigator of claim 6, further comprising a base portion attached to said barrel;
the removable tip being releasably secured to said base;
the removable tip portion being adjustable so that the dispensing point may be positioned at any angle with respect to a plane perpendicular to the axis of the syringe.

10. The irrigator of claim 9, where said irrigator has a least one set position within the plane perpendicular to the axis of the syringe.

11. The irrigator of claim 10, where said irrigator has at least four preset positions within the plane perpendicular to the axis of the syringe.

12. A periodontal pocket irrigator comprising:
a dispenser comprising a handle attached to a barrel, said barrel being attached to a dispensing tip;
a removable syringe having a plunger where a fluid is dispensed by the advancement of said plunger towards a dispensing end of said syringe, said removable syringe being releasably secured in said barrel so that said syringe is in fluid communication with said dispensing tip;
a battery-powered motor connected to the contained within said handle and mechanically linked to said plunger to dispense fluid from said syringe;
an actuator to control the operation of said motor and the advancement of the plunger;
said dispensing tip having two segments at an angle to one another, the second segment including a dispensing point from which the fluid is discharged.
means for positioning the dispensing point at multiple orientations with respect to the axis of the syringe.

13. The irrigator of claim 12 further comprising an illuminator.
